(19) United States
(12) Patent Application Publication
(10) Pub. No.: US 2025/0337158 A1
(43) Pub. Date: Oct. 30, 2025

(54) RADIO WAVE TRANSMISSIVE COVER

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: Takuya NAKAMURA, Nisshin-shi (JP)

(21) Appl. No.: 19/098,338

(22) Filed: Apr. 2, 2025

(30) Foreign Application Priority Data
Apr. 25, 2024 (JP) 2024-071957

(51) Int. Cl. H01Q 1/42; G01S 7/02

(52) U.S. Cl. CPC H01Q 1/42; G01S 7/027

(57) ABSTRACT

A radio wave transmissive cover is to be provided on a front side of a transmitting and receiving unit in a radio wave radar device and is configured to transmit a radio wave emitted from the transmitting and receiving unit. The radio wave transmissive cover includes a reflection suppression section configured to suppress reflection of the radio wave toward the transmitting and receiving unit. The reflection suppression section has a configuration in which a plurality of tapered portions are arranged, and each of the plurality of tapered portions has a hollow tapered shape that opens toward the transmitting and receiving unit.

### CROSS REFERENCE TO RELATED APPLICATION

The present application claims the benefit of priority from Japanese Patent Application No. 2024-071957 filed on Apr. 25, 2024. The entire disclosure of the above application is incorporated herein by reference.

### TECHNICAL FIELD

The present disclosure relates to a radio wave transmissive cover.

### BACKGROUND

Conventionally, a radio wave transmissive cover is provided on a front side of a transmitting and receiving unit in a radio wave radar device and the radio wave transmissive cover is configured to transmit a radio wave emitted from the transmitting and receiving unit.

### SUMMARY

A radio wave transmissive cover according to one example of the present disclosure is to be provided on a front side of a transmitting and receiving unit in a radio wave radar device and configured to transmit a radio wave emitted from the transmitting and receiving unit. The radio wave transmissive cover includes a reflection suppression section configured to suppress reflection of the radio wave toward the transmitting and receiving unit. The reflection suppression section has a configuration in which a plurality of tapered portions are arranged, and each of the plurality of tapered portions has a hollow tapered shape that opens toward the transmitting and receiving unit.

### BRIEF DESCRIPTION OF DRAWINGS

Objects, features and advantages of the present disclosure will become apparent from the following detailed description made with reference to the accompanying drawings. In the drawings:

FIG. 1 is a perspective view illustrating the appearance of a vehicle as an application example of a radio wave transmissive cover according to the present disclosure;

FIG. 2 is an enlarged cross-sectional view illustrating an area around a radio wave transmissive region illustrated in FIG. 1;

FIG. 3 is an enlarged cross-sectional view illustrating an example configuration of a reflection suppression section illustrated in FIG. 2;

FIG. 4 is an enlarged front view illustrating a part of a first layer illustrated in FIG. 3;

FIG. 5 is an enlarged perspective view illustrating one of a plurality of tapered portions illustrated in FIG. 3 and FIG. 4;

FIG. 6 is a conceptual diagram for explaining an incident angle;

FIG. 7 is a graph showing a relationship between the incident angle and a reflection coefficient on a dielectric surface;

FIG. 8 is a conceptual diagram illustrating reflection of a radio wave in the first layer illustrated in FIG. 3;

FIG. 9 is a graph showing an effect of the reflection suppression section illustrated in FIG. 3;

FIG. 10 is a graph showing another effect of the reflection suppression section illustrated in FIG. 3;

FIG. 11 is a graph showing another effect of the reflection suppression section illustrated in FIG. 3;

FIG. 12 is a schematic cross-sectional view illustrating a configuration of the reflection suppression section of the first embodiment illustrated in FIG. 3;

FIG. 13 is a schematic cross-sectional view illustrating a configuration of a reflection suppression section according to one modified example of the first embodiment;

FIG. 14 is a schematic cross-sectional view illustrating a configuration of a reflection suppression section according to another modified example of the first embodiment;

FIG. 15 is a schematic cross-sectional view illustrating a configuration of a reflection suppression section according to another modified example of the first embodiment;

FIG. 16 is a schematic cross-sectional view illustrating a configuration of a reflection suppression section according to a second embodiment of the present disclosure;

FIG. 17 is a schematic cross-sectional view illustrating a configuration of a reflection suppression section according to one modified example of the second embodiment;

FIG. 18 is a schematic cross-sectional view illustrating a configuration of a reflection suppression section according to another modified example of the second embodiment;

FIG. 19 is a schematic cross-sectional view illustrating a configuration of a reflection suppression section according to another modified example of the second embodiment;

FIG. 20 is a schematic cross-sectional view illustrating a configuration of a reflection suppression section according to another modified example of the second embodiment;

FIG. 21 is a schematic cross-sectional view illustrating a configuration of a reflection suppression section according to another modified example of the second embodiment;

FIG. 22 is an enlarged front view illustrating a configuration of a reflection suppression section according to a third embodiment of the present disclosure;

FIG. 23 is a cross-sectional view of the reflection suppression section taken along the line XXIII-XXIII of FIG. 22;

FIG. 24 is a perspective view illustrating the appearance of a vehicle to which a configuration according to one modified example of the present disclosure is applied;

FIG. 25 is an enlarged cross-sectional view illustrating an area around a radio wave radar device illustrated in FIG. 24; and

FIG. 26 is a schematic cross-sectional view illustrating a configuration of a reflection suppression section illustrated in FIG. 25.

### DETAILED DESCRIPTION

In case where a radome in a radar device has a shape parallel to a surface of an antenna, there is a possibility that the antenna will receive reflected waves reflected by the radome. The reflected wave can cause erroneous detection and reduce the sensitivity of the radar device.

When the radome has a specific shape, reflected waves by the radome can be suppressed. For example, a radome may be a single-layer dielectric plate radome, which has a convex shape having an apex on one side from a plane including a mounting periphery to be mounted to an antenna. The convex shape is, for example, a pyramid, a cone, or a dome.

A radio wave transmissive cover according to an aspect of the present disclosure is to be provided on a front side of a transmitting and receiving unit in a radio wave radar device and is configured to transmit a radio wave emitted from the transmitting and receiving unit. The radio wave transmissive cover includes a reflection suppression section configured to suppress reflection of the radio wave toward the transmitting and receiving unit. The reflection suppression section has a configuration in which a plurality of tapered portions are arranged, and each of the plurality of tapered portions has a hollow tapered shape that opens toward the transmitting and receiving unit.

The radio wave emitted from the transmitting and receiving unit provided in the radio wave radar device passes through the radio wave transmissive cover provided on the front side of the transmitting and receiving unit. In this case, with the radio wave transmissive cover having the above-described configuration, the reflection suppression section, which has the configuration in which the plurality of tapered portions each having the hollow tapered shape that opens toward the transmitting and receiving unit, effectively suppresses the reflection of the radio wave toward the transmitting and receiving unit. Therefore, with the radio wave transmissive cover having the above-described configuration, it is possible to effectively suppress erroneous detection or reduced sensitivity due to waves reflected from the radio wave transmissive cover.

Exemplary embodiments and specific examples (that is, examples and modified examples) of the present disclosure will be described below with reference to the drawings. In the following embodiments and the specific examples, the same reference numerals are given to the same or equivalent components. Therefore, with regard to components that have the same reference numerals as those in the preceding embodiments or the like, the descriptions in the preceding embodiments or the like may be appropriately applied to the subsequent embodiments or the like, unless there are technical inconsistencies or specific additional explanations.

### First Embodiment

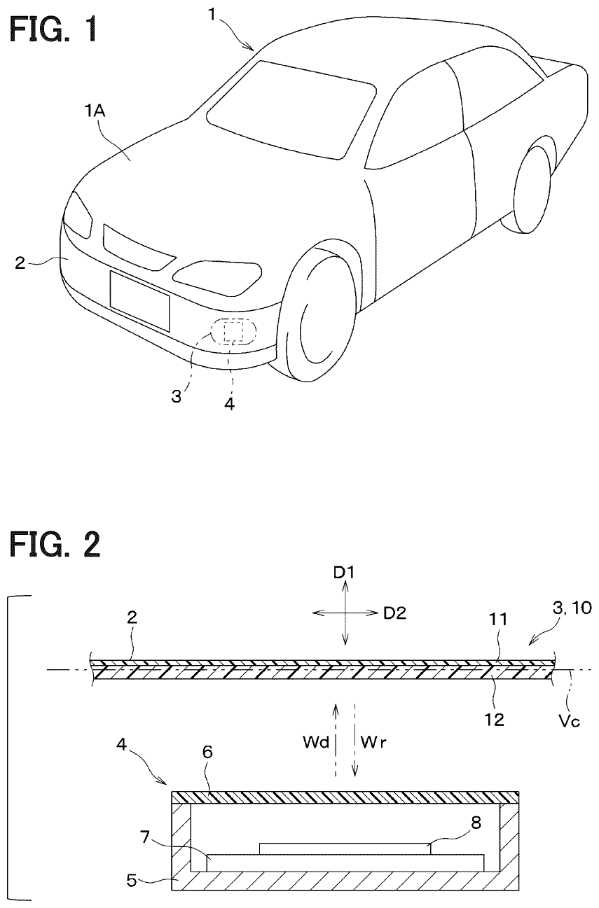

Referring to FIG. 1, a vehicle 1, as one application of the present disclosure, is an automobile that travels on public roads and is equipped with a vehicle body 1A having a box shape. A bumper 2, serving as a radio wave transmissive cover according to the present disclosure, is mounted on a front end portion and a rear end portion of the vehicle body 1A.

As shown in FIG. 2, the bumper 2 includes a first layer 11 and a second layer 12. The first layer 11 is made of a material that partially reflects radio waves. For example, the first layer 11 is made of a metallic paint. Strictly speaking, the metallic paint of the vehicle 1 consists of multiple layers; however, for simplicity, it will be described here as being formed of a single layer of high dielectric material. The second layer 12 is made of a material through which radio waves can pass, such as synthetic resin. A radio wave transmissive region 3 is provided at least in a portion of the bumper 2. In order to avoid complexity in the illustration, FIG. 2 shows the first layer 11 and the second layer 12 as having a flat shape. However, as will be described in detail later, the first layer 11 and the second layer 12 have a shape or structure designed to suppress the reflection of radio waves. The radio wave transmissive region 3 is configured to allow radio waves emitted from a radio wave radar device 4, which is positioned inside the bumper 2, to pass through effectively.

Referring to FIG. 2, the radio wave radar device 4 is located on the inside, or the rear side, of the bumper 2. For the sake of simplicity of illustration and description, in the present embodiment, the portion of the bumper 2 that faces the radio wave radar device 4 is shown as a macroscopically flat plate. However, as will be described later, the shape of the portion of the bumper 2 that faces the radio wave radar device 4 is not limited to this example. In the present disclosure, “macroscopically flat plate” means that the appearance is generally flat plate, specifically, that a virtual cover plane Vc is planar. The virtual cover plane Vc is a virtual plane that passes through the central position between a first virtual plane, which passes through an innermost position of the bumper 2, that is, an inner surface of the bumper 2 adjacent to the radio wave radar device 4, and a second virtual plane, which passes through an outermost position of the bumper 2, that is, an outer surface of the bumper 2 adjacent to the vehicle exterior space.

The first virtual plane, the virtual cover plane Vc, and the second virtual plane are, in this order, offset by a predetermined value along a thickness direction of the bumper 2. Twice this predetermined value corresponds to a macroscopic thickness of the bumper 2. The “macroscopic thickness of the bumper 2” refers to a thickness of the bumper 2 as a plate member of a certain thickness, without considering any irregularities that may be formed on the inner and outer surfaces of the plate member. The virtual cover plane Vc is a virtual plane that passes through the center position in the thickness direction of the plate member.

The radio wave radar device 4 includes a casing 5, a radome 6, and a transmitting and receiving unit 7. The casing 5, also referred to as a lower case, is a box-shaped member formed like a bathtub with an opening on one side, and is made of a material that is opaque to radio waves (for example, a metal such as aluminum). The radome 6 is a plate member provided so as to cover the opening of the casing 5, and is made of a material through which radio waves can easily pass (for example, synthetic resin).

The transmitting and receiving unit 7 is a circuit board on which an antenna 8 and the like are formed, and is supported by the casing 5 so as to be disposed opposite the radome 6. In the present embodiment, the radio wave radar device 4 is configured to operate at an operating frequency of 76 to 81 GHz, for example. The radio wave radar device 4 is held within the bumper 2 with the radome 6 facing the bumper 2.

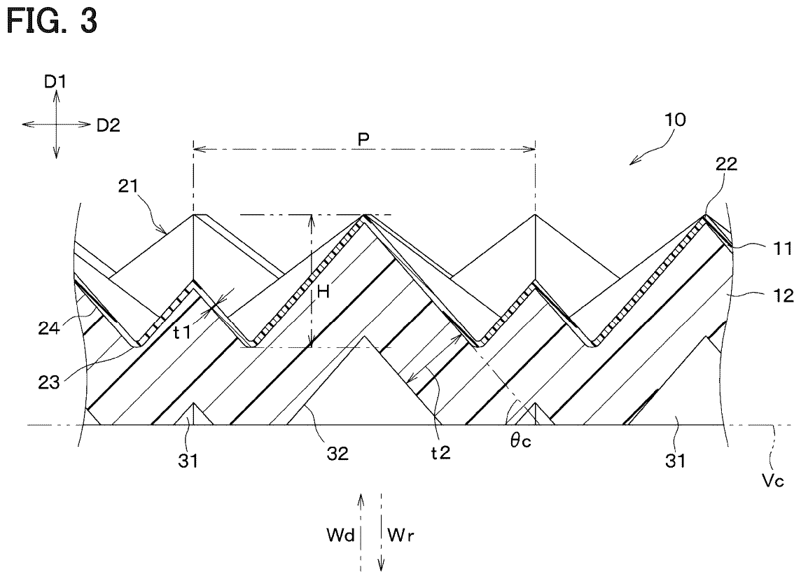

In FIG. 2, a transmission and reception direction D1 is a direction parallel to a direction in which a radiated wave Wd, which is a radio wave radiated from the radio wave radar device 4, propagates through space, and more specifically, is a direction parallel to a directional central axis of the radiated wave Wd. For the sake of simplicity of illustration and description, in the present embodiment, the transmission and reception direction D1 is shown as being normal to the virtual cover plane Vc, that is, an incident angle of the radiated wave Wd with respect to the virtual cover plane Vc is 0 degrees. However, as described below, the present disclosure is not limited to such an arrangement. A direction perpendicular to the transmission and reception direction D1, that is, a direction parallel to the virtual cover plane Vc, is referred to as a creeping direction D2. The transmission and reception direction D1 and the creeping direction D2 are illustrated in such a way that they are consistent with each other in FIG. 2 and in all subsequent drawings from FIG. 3.

In this manner, the bumper 2 serving as the radio wave transmissive cover is provided on the front side of the transmitting and receiving unit 7 so as to transmit the radiated wave Wd, which is the radio wave radiated from the transmitting and receiving unit 7 provided in the radio wave radar device 4. At least a part of the radio wave transmissive region 3 of the bumper 2, which is an area through which the radiated wave Wd passes, is provided with a reflection suppression section 10.

The reflection suppression section 10 has a structure that suppresses the reflection of the radiated wave Wd to the transmitting and receiving unit 7, that is, the generation of an internally reflected wave Wr. The internally reflected wave Wr is a radio wave caused by the radiated wave Wd that propagates toward the transmitting and receiving unit 7 without passing through the bumper 2, and is typically a wave reflected by the bumper 2. In the present embodiment, the first layer 11 and the second layer 12 of the reflection suppression section 10 having a two-layer structure as described below are each made of a dielectric material having a relative dielectric constant of 2 to 20. As will be described later, when the reflection suppression section 10 is formed of three or more layers, each of the three or more layers is made of a dielectric material having a relative dielectric constant of 2 to 20. Similarly, when the reflection suppression section 10 has a single-layer structure, the reflection suppression section 10 having such a single-layer structure is made of a dielectric material having a relative dielectric constant of 2 to 20.

With reference to FIG. 3, the reflection suppression section 10 according to the present embodiment has a laminated structure of the first layer 11 and the second layer 12, which are two dielectric layers. The first layer 11 is thinner than the second layer 12 and is made of a material with a high dielectric constant. Specifically, in the present embodiment, the first layer 11 is made of a dielectric material with a relative dielectric constant of 5.5 and has a thickness t1 of 0.1 mm (that is, approximately 0.026 times the wavelength). On the other hand, the second layer 12 is made of a dielectric material having a relative dielectric constant of 2.5 and has a thickness t2 of 1.7 mm (that is, approximately 0.44 times the wavelength).

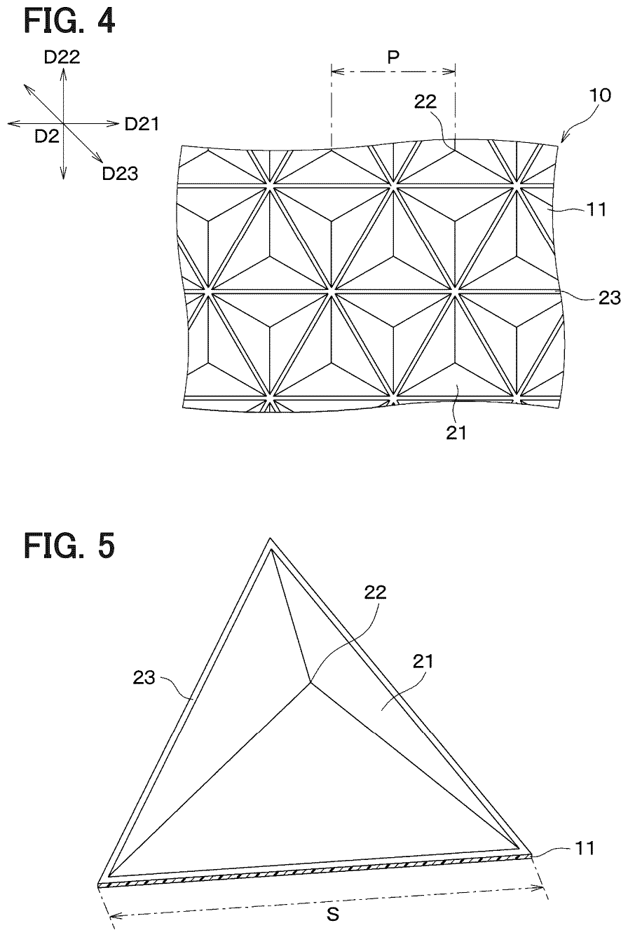

As shown in FIG. 3 and FIG. 4, the first layer 11 has a configuration in which a plurality of tapered portions 21 are arranged two-dimensionally in the creeping direction D2. Each of the tapered portions 21 has a hollow tapered shape that opens toward a propagation direction of the internally reflected wave Wr (that is, toward the transmitting and receiving unit 7). In the present embodiment, each of the tapered portions 21 is formed in a triangular pyramid shape having an apex 22 and a triangular base 23, as shown in FIG. 4 and FIG. 5. The apex 22 may have an angular shape, a flattened shape, or a rounded shape. The base 23 has an equilateral triangular shape in the creeping direction D2.

The tapered portions 21, each having a triangular pyramid shape with an equilateral triangular bottom, are densely arranged in the creeping direction D2 so that an arrangement period P is 0.25 to 1.5 times the wavelength of the radiated wave Wd. As shown in FIG. 4, the arrangement period P is the distance between adjacent apexes 22 in a first creeping direction D21 that is parallel to one side of the equilateral triangle at the base 23 within the creeping direction D2. Of the creeping directions D2, a direction perpendicular to the first creeping direction D21 is referred to as a second creeping direction D22, and a direction in which the radius of a circle centered at a certain point extends is referred to as a radial direction D23.

As shown in FIG. 5, the size S of the tapered portion 21, which corresponds to a size of the base 23, is a length of one side of the equilateral triangle at the base 23 of the hollow tapered shape. In the present embodiment, the size S of the tapered portion 21 is set to be 0.25 to 1.5 times the wavelength of the radiated wave Wd. Specifically, for example, when the size S of the tapered portion 21 is 1.15 times the wavelength of the radiated wave Wd, the size S is about 4.5 mm. As shown in FIG. 3 and FIG. 4, the tapered portions 21 arranged two-dimensionally in the creeping direction D2 are formed so that sizes S of the tapered portions 21 are uniform.

As shown in FIG. 3, an inner tapered surface 24, which is an inner surface of the tapered portion 21, that is, a surface on the opening side, is inclined with respect to the transmission and reception direction D1 or the creeping direction D2 so that a reflection coefficient of radio waves is less than −6 dB. Specifically, the inclination angle θc of the inner tapered surface 24 with respect to the virtual cover plane Vc can be set to a value between 30 and 75 degrees. More specifically, for example, when a height H of the tapered portion 21 is set to 1.83 mm (that is, approximately 0.47 times the wavelength), it is preferable that an inclination angle θc of the inner tapered surface 24 is set to approximately 50 degrees.

As described above, the first layer 11 is formed of a plate or film material having a predetermined thickness t1 and has a structure in which the plurality of tapered portions 21 of a predetermined size are densely arranged two-dimensionally in the creeping direction D2. Therefore, a thickness direction that defines the thickness t1 of the first layer 11 is inclined by 90-θc degrees with respect to the thickness direction of the bumper 2 that is perpendicular to the virtual cover plane Vc. The same applies to a thickness direction that defines the thickness t2 of the second layer 12. Therefore, the second layer 12 has recessed portions 31 that open in the same direction as the tapered portions 21 at positions corresponding to the tapered portions 21 in the creeping direction D2. An inner recessed surface 32, that is a surface of the recessed portion 31 is formed as an inclined surface along the inner tapered surface 24. Thus, in the present embodiment, the hollow tapered shape is provided in both the first layer 11 and the second layer 12.

The effects achieved by the configuration according to the present embodiment will be described below together with the mechanism by which these effects are achieved. The radiated wave Wd, which is the radio wave radiated from the transmitting and receiving unit 7 provided in the radio wave radar device 4, passes through the radio wave transmissive region 3 in the bumper 2 that serves as the radio wave transmitting cover provided in front of the transmitting and receiving unit 7. The radio wave transmissive region 3 is a dielectric body having a plate shape.

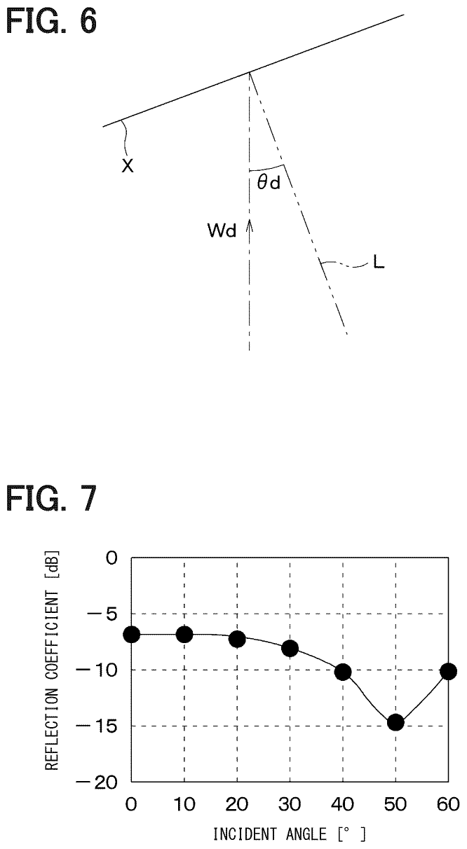

It is generally known that when a radio wave with a polarization plane perpendicular to a surface of the dielectric body is incident at a large angle, the amount of reflection is greatly reduced. FIG. 6 and FIG. 7 are diagrams illustrating the general properties of radio wave reflection when the radiated wave Wd is incident on an incident surface X, which is a surface of a dielectric body. As is well known, the incident angle θd of the radiated wave Wd is defined with respect to the normal line L on the incident surface X. That is, when the radiated wave Wd is perpendicularly incident on the incident surface X, the incident angle θd is 0 degrees.

As shown in FIG. 7, the reflection coefficient decreases more significantly when the incident angle θd is between 30 and 60 degrees than when the incident angle θd is 0 degrees. This tendency is observed up to an incident angle θd of about 75 degrees. For this reason, as shown in FIG. 3, the reflection suppression section 10 has a structure in which a large number of tapered portions 21 are provided, each having the inner tapered surface 24 that is inclined with respect to the virtual cover plane Vc. In such a structure, the incident angle θd with respect to the inner tapered surface 24 corresponds to the inclination angle θc of the inner tapered surface 24 with respect to the virtual cover plane Vc. In this way, by making the surface of the dielectric body that reflects the radiated wave Wd an inclined surface like the inner tapered surface 24, the reflection coefficient is reduced, thereby making it possible to effectively suppress the internally reflected wave Wr.

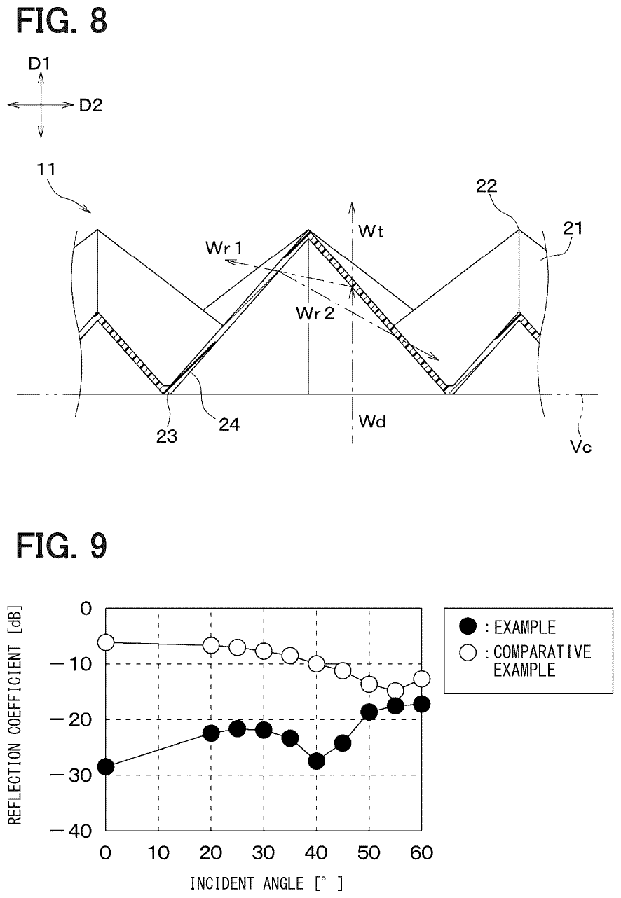

FIG. 8 schematically shows the reflection of the radio wave on the inner tapered surface 24. As shown in FIG. 8, a portion of the radiated wave Wd incident on the inner tapered surface 24 passes through the first layer 11 and becomes a transmitted wave Wt that is radiated toward the vehicle exterior shape, and the remaining portion is reflected at the inner tapered surface 24 and becomes a primary internally reflected wave Wr1. A propagation direction of the primary internally reflected wave Wr1 intersects with the transmission and reception direction D1. Furthermore, a propagation direction of a secondary internally reflected wave Wr2, which is a wave re-reflected by the inner tapered surface 24 of the primary internally reflected wave Wr1, also intersects with the transmission and reception direction D1. Thus, with this configuration, by making the propagation direction of the majority of the reflected waves a direction that intersects with the transmission and reception direction D1, it is possible to effectively suppress the internally reflected wave Wr that travel along the transmission and reception direction D1 toward the transmitting and receiving unit 7.

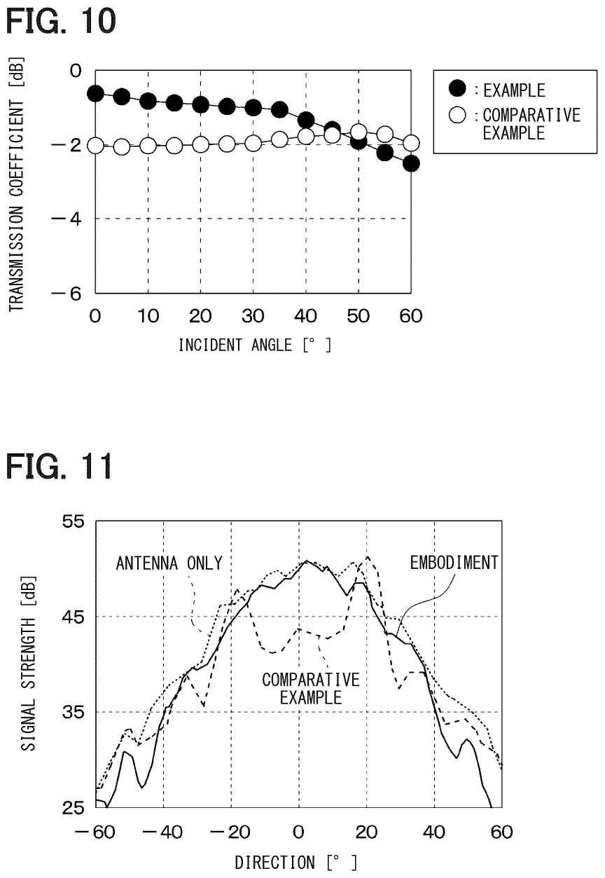

FIG. 9 is a graph showing a comparison of the reflection coefficient between an example and a comparative example. FIG. 10 is a graph showing a comparison of the transmission coefficient between the example and the comparative example. In FIG. 9 and FIG. 10, plots of the example shown by black circles indicate a case of a dielectric plate having the structure shown in FIG. 3, and plots of the comparative example shown by white circles indicate a case of a dielectric plate having a flat single-layer structure of uniform thickness. Methods for measuring the reflection coefficient and the transmission coefficient are well known at the time of filing the present application, and therefore detailed description thereof will be omitted in the present specification. As shown in FIG. 9 and FIG. 10, it has been confirmed that the configuration according to the present embodiment can provide a better reflection coefficient and a better transmission coefficient than the dielectric plate of uniform thickness.

FIG. 11 shows a radiation pattern of the radiated wave Wd. In FIG. 11, the dotted line indicates the radiation pattern by the antenna 8 only, the solid line indicates the radiation pattern of the transmitted wave Wt that has passed through the reflection suppression section 10 of the present embodiment, and the dashed line indicates the radiation pattern of the transmitted wave Wt that has passed through the dielectric plate of the comparative example having the flat single-layer structure. As shown in FIG. 11, in the comparative example, a signal strength decreased within a direction range of −15 to +15 degrees, where the influence of reflection is large. In contrast, according to the present embodiment, such a decrease in signal strength was not observed, and a radiation pattern similar to that obtained in the case of the antenna 8 only was obtained.

In this way, in the present embodiment, the reflection of the radio wave to the transmitting and receiving unit 7 is effectively suppressed by the reflection suppression section 10, which is configured with the plurality of tapered portions 21, each having the hollow tapered shape that opens toward the transmitting and receiving unit 7. Specifically, according to the present embodiment, it is possible to effectively suppress erroneous detection or reduced sensitivity due to internally reflected wave Wr by reducing the reflection coefficient using the inclined surface and controlling the propagation direction of the reflected waves. Furthermore, by optimizing the shape and the arrangement period P of the tapered portions 21, it is possible to more effectively suppress the internally reflected wave Wr heading toward the transmitting and receiving unit 7.

Therefore, according to the present embodiment, it is possible to effectively suppress erroneous detection or reduced sensitivity due to the internally reflected wave Wr, which is the wave reflected by the bumper 2. In particular, it is possible to improve the transmittance and reduce the reflectance by simply providing a specific structure without changing the material of the bumper 2 serving as the radio wave transmissive cover.

### Modified Examples

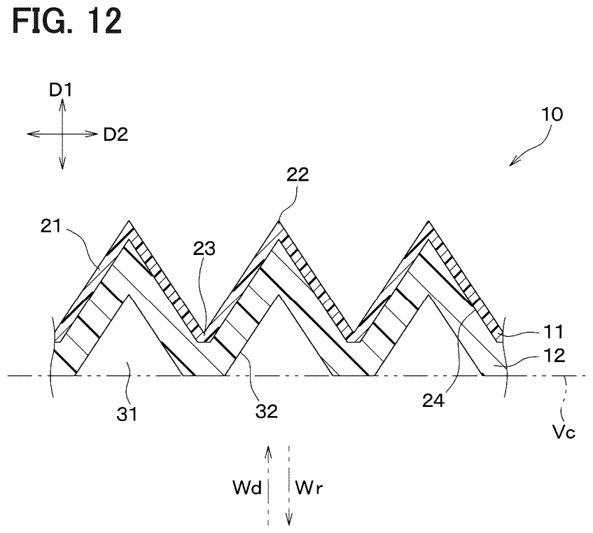

As shown in FIG. 12, the above-described embodiment has a configuration in which the first layer 11 having the tapered portions 21 is formed on the second layer 12. Such a configuration can be realized, for example, in the form of the second layer 12 serving as a support layer constituting the main body portion of the bumper 2 shown in FIG. 2, and the first layer 11 serving as a coating layer formed on the support layer. In the above embodiment, the second layer 12 has the recessed portions 31, so that the hollow tapered shape is provided in both the first layer 11 and the second layer 12.

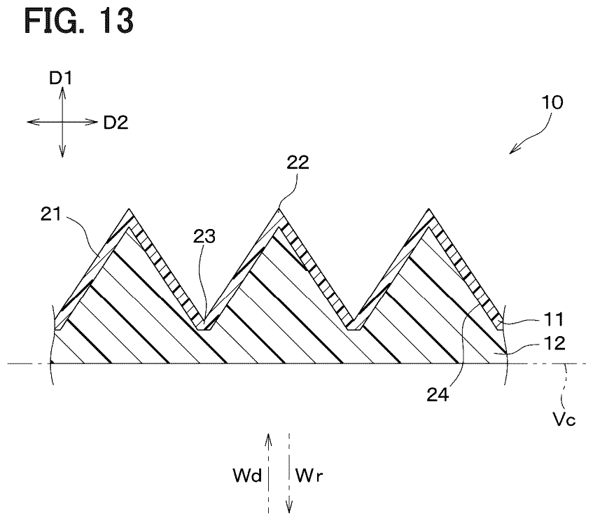

In contrast, in the configuration according to a modified example shown in FIG. 13, an inner surface, that is, a bottom surface, of the second layer 12 is a smooth surface without any recessed portion 31. That is, in this modified example, the second layer 12 has a configuration in which solid pyramids are arranged two-dimensionally. Even in the modified example described above, the tapered portions 21 are provided in the first layer 11 on the high dielectric constant side in the two-layer laminate structure consisting of the first layer 11 and the second layer 12, and inner tapered surfaces 24 of the tapered portions 21 are made into inclined surfaces, thereby achieving the same reflection reduction effect as the above-described embodiment. In this case, the thickness direction of the second layer 12 is along (that is, parallel to) the transmission and reception direction D1.

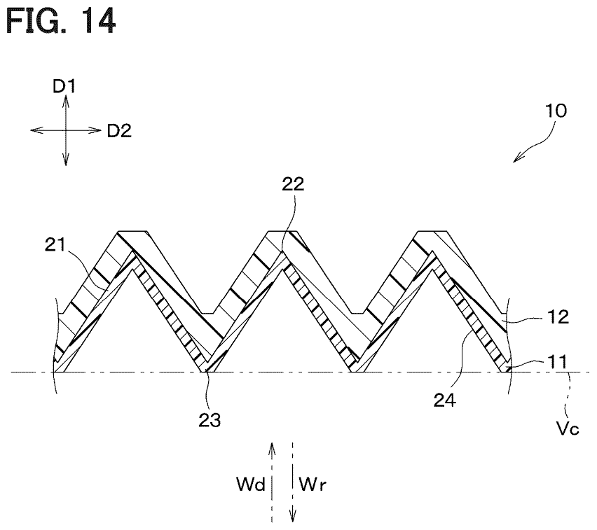

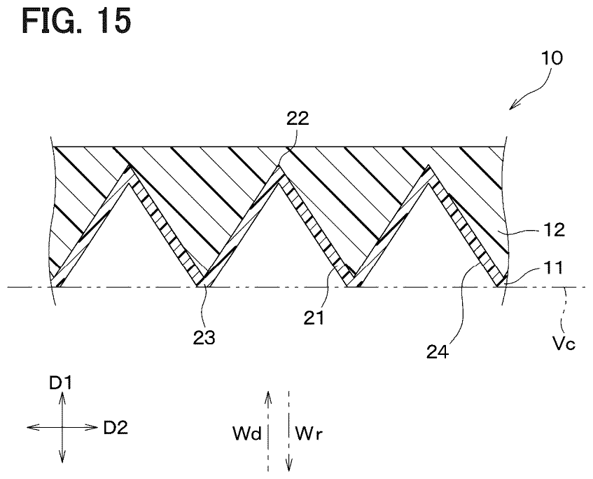

FIG. 14 shows a configuration in which the positional relationship between the first layer 11 and the second layer 12 in the transmission and reception direction D1, that is, the front and rear, is reversed from the configuration shown in FIG. 12. Similarly, in FIG. 15, the positional relationship between the first layer 11 and the second layer 12 in the transmission and reception direction D1 is reversed from the configuration shown in FIG. 13. With these configurations, the same reflection suppression effect as the above-described embodiment can be achieved.

### Second Embodiment

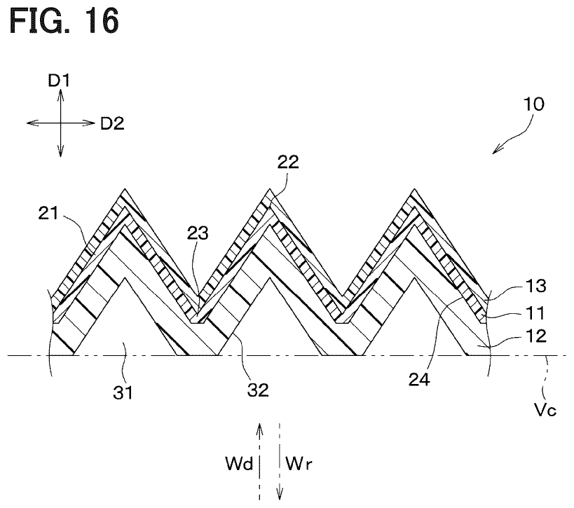

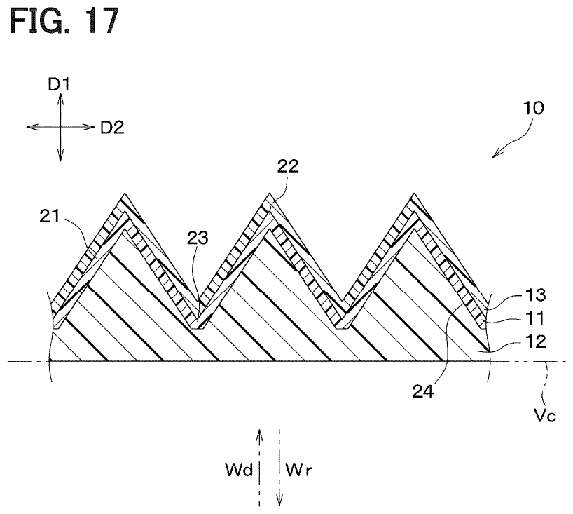

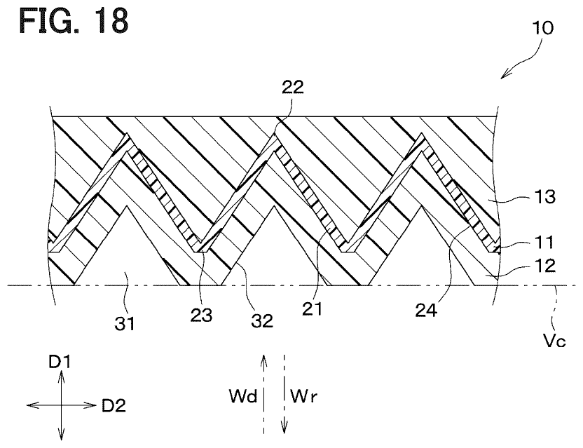

In the present embodiment, the reflection suppression section 10 has a three-layer structure including a first layer 11, a second layer 12, and a third layer 13. That is, the configuration shown in FIG. 16 is obtained by adding a third layer 13 to the outside of the first layer 11 in comparison with the configuration shown in FIG. 12. Similarly, the configuration shown in FIG. 17 is obtained by adding a third layer 13 to the outside of the first layer 11 in comparison with the configuration shown in FIG. 13. The third layer 13 is provided as a dielectric layer having a lower dielectric constant than the first layer 11.

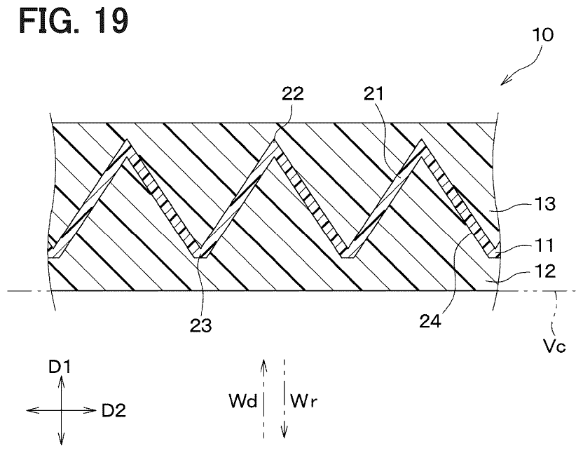

Such a configuration can be realized, for example, in the form of the second layer 12 as a support layer constituting the main body portion of the bumper 2 shown in FIG. 2, the first layer 11 as a coating layer formed on the support layer, and the third layer 13 as a protective layer formed on the coating layer. With this configuration as well, the same reflection suppression effect as the above-described embodiment can be achieved. As shown in FIG. 18 and FIG. 19, an outer surface, that is, a top surface, of the third layer 13 may be a smooth surface without irregularities.

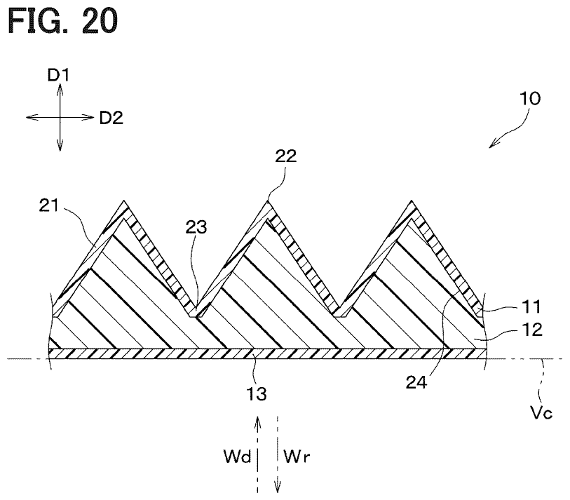

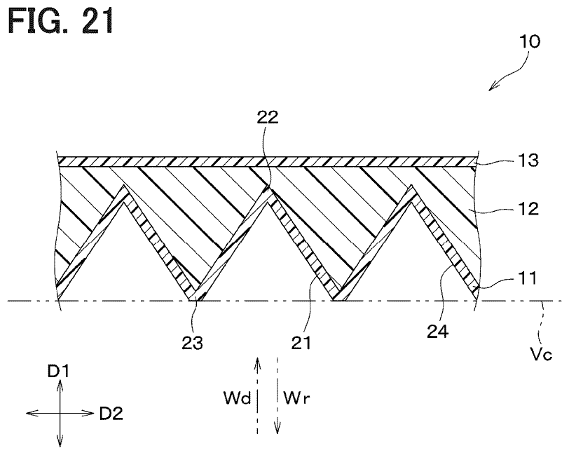

In the configurations shown in FIG. 20 and FIG. 21, the third layer 13 is a high dielectric constant layer joined to the second layer 12 and is made of a material having a higher dielectric constant than the second layer 12. That is, the configuration shown in FIG. 20 is obtained by adding the third layer 13 of a certain thickness to the inner surface of the smooth second layer 12 in comparison with the configuration shown in FIG. 13. Similarly, the configuration shown in FIG. 21 is obtained by adding the third layer 13 of a certain thickness to an outer surface of the smooth second layer 12 in comparison with the configuration shown in FIG. 15. In these examples, the second layer 12 having a low dielectric constant is positioned between the first layer 11 and the third layer 13 having a high dielectric constant. With such a configuration as well, the same reflection suppression effect as the above-described embodiment can be achieved.

As described above in detail, the configuration according to the present disclosure has the tapered portions 21 provided in at least one of the reflection suppression section 10 having a laminated structure of a plurality of dielectric layers. This makes it possible to effectively suppress the internally reflected wave Wr traveling toward the transmitting and receiving unit 7, thereby making it possible to effectively suppress erroneous detection or reduced sensitivity due to the internally reflected wave Wr.

### Third Embodiment

In each of the above-described embodiments, the sizes S of the tapered portions 21 and the arrangement periods P of the tapered portions 21 are uniform in the creeping direction D2. In contrast, in the present embodiment, the sizes S and the arrangement periods P of the tapered portions 21 are non-uniform.

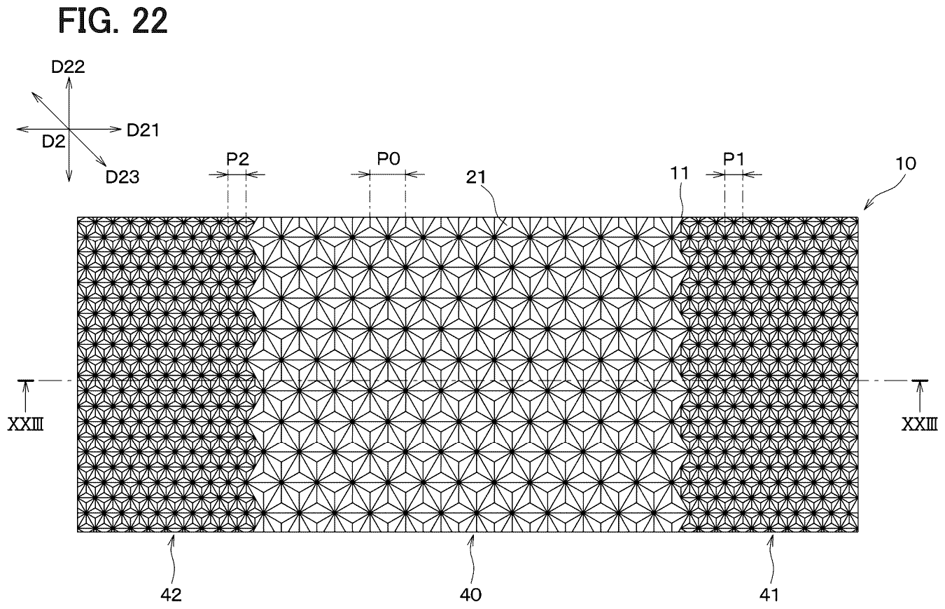

Specifically, as shown in FIG. 22, the reflection suppression section 10 has an inner region 40, a first outer region 41, and a second outer region 42. The first outer region 41, the inner region 40, and the second outer region 42 are arranged in this order along the first creeping direction D21. That is, the inner region 40 is sandwiched between the first outer region 41 and the second outer region 42. In other words, the first outer region 41 and the second outer region 42 are disposed outside the inner region 40 in the creeping direction D2.

The inner region 40 has tapered portions 21 of a different size than the first outer region 41 and the second outer region 42. That is, the tapered portions 21 are formed so that the sizes S of the tapered portions 21 are larger in the inner region 40 than in the first outer region 41 and the second outer region 42. Moreover, the tapered portions 21 are formed so that the arrangement period P in the inner region 40 is larger than those in the first outer region 41 and the second outer region 42.

That is, an inner arrangement period PO, which is the arrangement period P in the inner region 40, is set larger than a first outer arrangement period P1, which is the arrangement period P in the first outer region 41, and a second outer arrangement period P2, which is the arrangement period P in the second outer region 42. According to this configuration, it is possible to satisfactorily achieve a reflection suppression effect according to the directional characteristics.

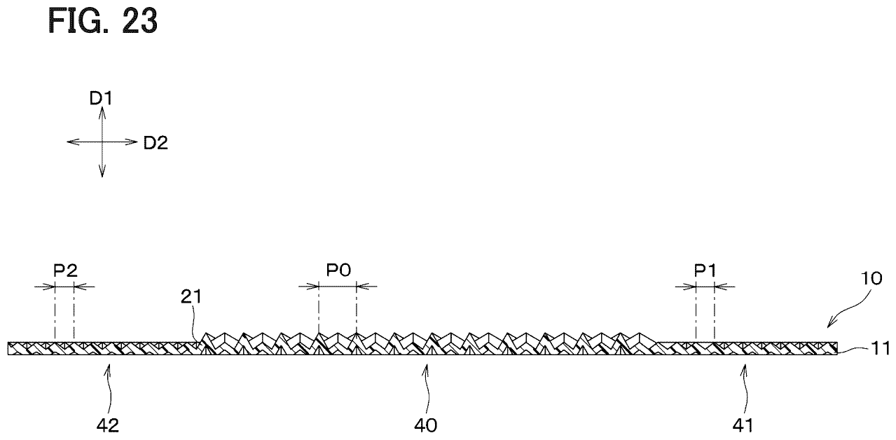

In the configuration examples shown in FIG. 22 and FIG. 23, the sizes S of the tapered portions 21 provided in the inner region 40 are uniform. In addition, the sizes S of the tapered portions 21 provided in the first outer region 41 and the second outer region 42 are uniform. Moreover, the sizes S of the tapered portions 21 are the same in the first outer region 41 and the second outer region 42. Furthermore, the first outer arrangement period P1 and the second outer arrangement period P2 are the same. However, the present disclosure is not limited to this example.

For example, the tapered portions 21 may have a distribution in size in the inner region 40, the first outer region 41, and the second outer region 42. That is, for example, the sizes S of the tapered portions 21 in the inner region 40 may be made smaller from a center position of the inner region 40 in the creeping direction D2 toward the outside. Note that, the term “from the center position toward the outside” means from the center position toward the first creeping direction D21, the second creeping direction D22, or the radial direction D23. As a result, the inner arrangement period P0 may also have a distribution.

Furthermore, the sizes S of the tapered portions 21 may be different between the first outer region 41 and the second outer region 42. Furthermore, in the first outer region 41 and the second outer region 42, the tapered portions 21 may have a distribution in size. Specifically, for example, in the first outer region 41 and the second outer region 42, the tapered portions 21 may become smaller with increasing distance from the inner region 40. As a result, the first outer arrangement period P1 and the second outer arrangement period P2 may also have a distribution.

### Other Modified Examples

The present disclosure is not limited to the embodiments and the examples described above. Therefore, the above embodiments can be appropriately changed. Hereinafter, typical modified examples will be described. In the following description of the modified examples, differences from the above embodiments will be mainly described. In the above embodiments and the following modified examples, the same reference numerals are assigned to the same or equivalent parts. Therefore, in the following description of the modified examples, the description in the above embodiments can be appropriately incorporated for the components having the same reference numerals as those in the above embodiments, unless there is a technical contradiction or a special additional description.

The present disclosure is not limited to the specific applications and the device configurations described in the above-described embodiments. That is, for example, application of the present disclosure is not limited to automobiles that travel on public roads. In addition, there are no particular limitations on the type of automobile.

As described above, in the above-described embodiments, for the sake of simplicity of illustration and description, the virtual cover plane Vc is assumed to be planar. However, the present disclosure is not limited to this example. That is, the radio wave transmissive region 3 is not limited to being in the shape of a flat plate when viewed from a macroscopic perspective, but may be in the shape of a curved plate when viewed from a macroscopic perspective. In other words, the virtual cover plane Vc may be curved.

The radio wave transmissive region 3 may be provided in a part of the bumper 2 or may be provided over the entire bumper 2. Similarly, the reflection suppression section 10 may be provided in a part of the radio wave transmissive region 3 or may be provided in the entire area of the radio wave transmissive region 3. The first layer 11 may have a single-layer structure or a multi-layer structure. Each of the second layer 12 and the third layer 13 may have a single-layer structure or a multi-layer structure. The reflection suppression section 10 may further include additional layers, such as a fourth layer and a fifth layer.

The shape of each of the tapered portions 21 is also not limited to the triangular pyramid, but may be an N-sided pyramid having a base 23 of any shape, or may be a cone. N is an integer of 1 or more. In the case of N=4, that is, a square pyramid, the size S of the tapered portion 21 is a length of one side of a square shape of the base 23. In the case of N≥5, the size S of the tapered portion 21 is a diameter of a circumscribing circle. In the case of a cone, the size S of the tapered portion 21 is a diameter of the base 23.

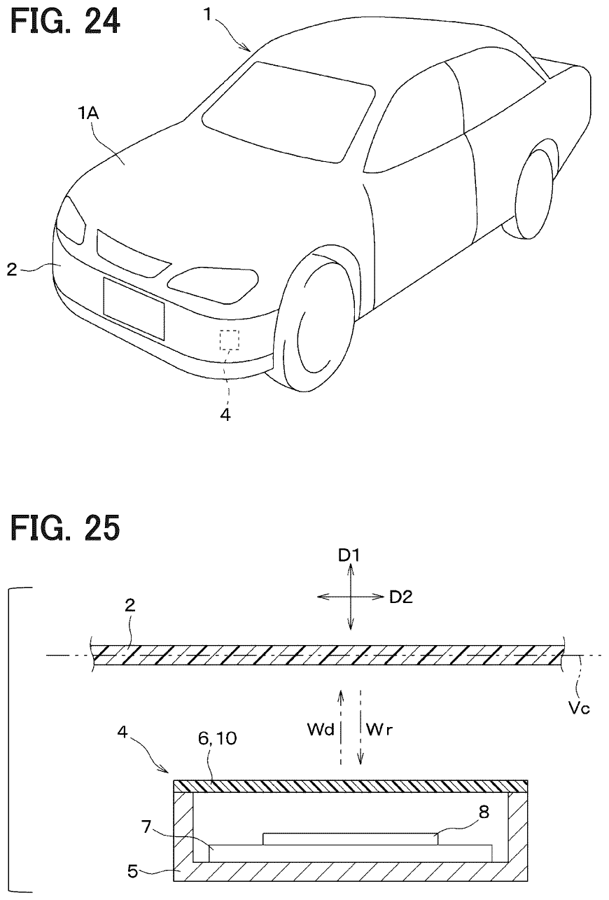

In each of the above-described embodiments, an example has been described in which the radio wave transmissive cover according to the present disclosure is the bumper 2, but the present disclosure is not limited to this example. That is, for example, the radio wave transmissive cover according to the present disclosure may be a radome 6. The appearance of the vehicle 1 in this case is shown in FIG. 24.

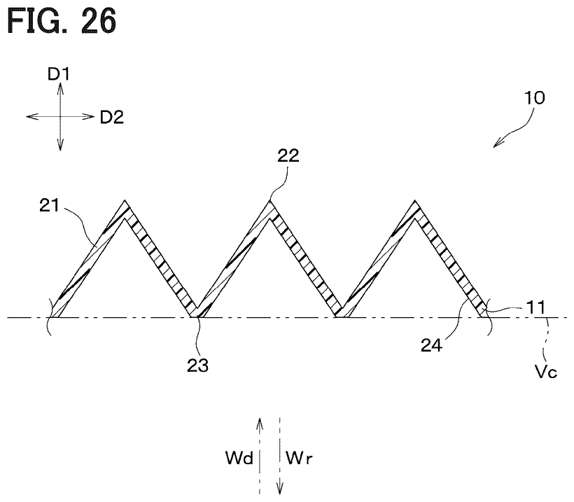

In the configuration of this modified example shown in FIG. 24, the bumper 2 may have the radio wave transmissive region 3 shown in FIG. 1, similarly to the above-described embodiments. That is, this modified example and the above-described embodiments can be combined with each other. In this modified example, as shown in FIG. 25, the reflection suppression section 10 can be provided on at least a part of the radome 6. The reflection suppression section 10 in the radome 6 may have a single-layer structure made up of only the first layer 11 in the above-described embodiments, as shown in FIG. 26. Also, for example, the radio wave transmissive cover according to the present disclosure may be a vehicle body part other than the bumper 2 (for example, an emblem attached to the front grille, and the like).

In the above description, a plurality of elements formed integrally with each other with no seam may be formed by bonding separate members together. Similarly, a plurality of elements formed by bonding separate members together may be formed integrally with each other with no seam. In the above description, a plurality of elements made of the same material may be made of different materials. Similarly, a plurality of elements made of different materials may be made of the same material.

The constituent element(s) of each of the above embodiments is/are not necessarily essential unless it is specifically stated that the constituent element(s) is/are essential in the above embodiments, or unless the constituent element(s) is/are obviously essential in principle. In addition, in the case where the number of the constituent element(s), the value, the amount, the range, and/or the like is specified, the present disclosure is not necessarily limited to the number of the constituent element(s), the value, the amount, and/or the like specified in the embodiment unless the number of the constituent element(s), the value, the amount, and/or the like is indicated as essential or is obviously essential in view of the principle. Similarly, in the case where the shape, the direction, the positional relationship, and/or the like of the constituent element(s) is specified, the present disclosure is not necessarily limited to the shape, the direction, the positional relationship, and/or the like unless the shape, the direction, the positional relationship, and/or the like is/are indicated as essential or is/are obviously essential in principle.

The modified examples are not limited to the above-described examples. For example, all or part of one embodiment and all or part of another embodiment can be combined together as long as there is no technical conflict. Similarly, all or part of one of the modified examples and all or part of another one of the modified examples may be combined together as long as there is no technical conflict.

What is claimed is:

1. A radio wave transmissive cover to be provided on a front side of a transmitting and receiving unit in a radio wave radar device and configured to transmit a radio wave emitted from the transmitting and receiving unit, the radio wave transmissive cover comprising:
a reflection suppression section configured to suppress reflection of the radio wave toward the transmitting and receiving unit, wherein
the reflection suppression section has a configuration in which a plurality of tapered portions are arranged, and each of the plurality of tapered portions has a hollow tapered shape that opens toward the transmitting and receiving unit.

2. The radio wave transmissive cover according to claim 1, further comprising:
a laminated structure of a plurality of dielectric layers, wherein
at least one of the plurality of dielectric layers has the plurality of tapered portions.

3. The radio wave transmissive cover according to claim 1, wherein
the reflection suppression section is made of a dielectric material having a relative dielectric constant of 2 to 20.

4. The radio wave transmissive cover according to claim 1, wherein
each of the plurality of tapered portions has an inner tapered surface that faces the transmitting and receiving unit, and the inner tapered surface is inclined so that a reflection coefficient of the radio wave is less than −6 dB.

5. The radio wave transmissive cover according to claim 4, wherein
the inner tapered surface is inclined at an inclination angle of 30 to 75 degrees.

6. The radio wave transmissive cover according to claim 1, wherein
the plurality of tapered portions have bases, respectively, and sizes of the bases are 0.25 to 1.5 times a wavelength of the radio wave.

7. The radio wave transmissive cover according to claim 6, wherein
the sizes of the bases of the plurality of tapered portions are non-uniform.

8. The radio wave transmissive cover according to claim 1, wherein
the plurality of tapered portions are arranged with arrangement periods of 0.25 to 1.5 times a wavelength of the radio wave.

9. The radio wave transmissive cover according to claim 8, wherein
the arrangement periods of the plurality of tapered portions are non-uniform.

10. The radio wave transmissive cover according to claim 1, wherein
the hollow tapered shape is a triangular pyramid shape.
